(19) United States
(12) Patent Application Publication
(10) Pub. No.: US 2020/0223166 A1
(43) Pub. Date: Jul. 16, 2020

(54) APPARATUS AND METHOD OF ELIMINATING CORE CRUSH

(71) Applicant: The Boeing Company, Chicago, IL (US)

(72) Inventors: David Sundquist, O'Fallon, MO (US); Garrett Peters, St. Louis, MO (US)

(73) Assignee: The Boeing Company, Chicago, IL (US)

(21) Appl. No.: 16/248,063

(22) Filed: Jan. 15, 2019

(51) Int. Cl. B29D 24/00

(52) U.S. Cl. CPC B29D 24/007; B32B 7/12

(57) ABSTRACT

A substructure and its method of use eliminates core crush during the manufacturing of a hybrid sandwich-structured composite panel. The substructure is used in the manufacturing of the hybrid sandwich-structured composite panel by positioning a core of the composite panel in a cavity of the substructure and positioning the substructure and the core between layers of composite material where the substructure protects the core from core crush as the hybrid sandwich-structured composite panel is subjected to vacuum pressure and heat during autoclaving and then cured.

### FIELD

This disclosure pertains to a hybrid sandwich-structured composite panel having a substructure that is used in eliminating core crush during the manufacturing of the hybrid sandwich-structured composite panel. More specifically, this disclosure pertains to a method of using a substructure having a central cavity and a sloped outer side wall to eliminate core crush during the manufacturing of a hybrid sandwich-structured composite panel. The substructure is used in the manufacturing of the hybrid sandwich-structured composite panel by positioning a core of the composite panel in a cavity of the substructure and positioning the substructure and the core between layers of composite material where the substructure protects the core from core crush as the hybrid sandwich-structured composite panel is subjected to vacuum pressure and heat during autoclaving and then cured.

### BACKGROUND

In the manufacturing of sandwich-structured composite panels comprised of a center core and first and second face sheets on opposite sides of the core, core crush can occur during the manufacturing. Core crush typically occurs at locations along the peripheral edge of the core. Core crush can be caused by several factors, such as the ramp angle of the face sheets at the peripheral edge of the core, the vacuum pressure applied at the peripheral edge of the core during manufacturing of the composite panel, the ply count or number of face sheets positioned over the opposite sides of the core, movement of the face sheets positioned over the opposite sides of the core as vacuum pressure and heat are applied to the composite panel, as well as other possible causes. Any core crush that occurs during the manufacturing of the composite panel damages the composite panel. There is no satisfactory repair method for core crush, thus it is necessary that the damaged composite panel be scrapped.

### SUMMARY

The substructure of this disclosure and its method of use eliminate core crush in the manufacturing of a hybrid sandwich-structured composite panels.

The substructure is constructed of a thermoplastic material, or other equivalent type of material that is able to withstand the high temperatures and high vacuum pressure of a composite panel autoclave and cure cycle.

The substructure has a planar, bottom surface. The bottom surface has an outer perimeter edge that extends around the bottom surface.

In some situations, for example where the composite panel being manufactured with the substructure has a curvature, the bottom surface will have a curvature that matches the curvature of the panel being manufactured. The bottom surface is continuous inside the outer perimeter edge.

The substructure also has a planar, top surface spaced above the bottom surface. The top surface has a cavity recessed into the top surface at a central location of the top surface. The cavity extends downward from the top surface to a bottom support surface at a bottom of the cavity. The cavity in the top surface has an inner perimeter edge that extends around the cavity and is coplanar with the top surface. The top surface also has an outer perimeter edge that extends around the top surface and extends around the inner perimeter edge of the top surface.

If the composite panel being manufactured with the substructure has a curvature, the top surface will have a curvature that matches the curvature of the panel being manufactured.

The outer perimeter edge of the bottom surface has a length dimension. The outer perimeter edge of the top surface has a length dimension. The length dimension of the outer perimeter edge of the bottom surface is larger than the length dimension of the outer perimeter edge of the top surface, and the outer perimeter edge of the bottom surface extends around and is spaced outwardly from the outer perimeter edge of the top surface.

An inner side wall surface extends between the inner perimeter edge of the top surface and the support surface at the bottom of the cavity. The inner side wall surface extends completely around the cavity and extends completely around the inner perimeter edge of the top surface. The inner side wall surface defines a hybrid core bay or the volume of the cavity in the substructure between the support surface and the top surface.

A planar outer flange or tab extends around the periphery of the substructure. The flange is parallel with the bottom surface of the substructure, the top surface of the substructure and the support surface of the substructure. The flange has an outer perimeter edge that is coincident with the outer perimeter edge of the bottom surface. The flange has an inner perimeter edge that is spaced inwardly from the outer perimeter edge of the flange.

If the composite panel being manufactured with the substructure has a curvature, the flange will have a curvature that matches the curvature of the panel being manufactured.

An outer side wall surface extends between the outer perimeter edge of the top surface and the inner perimeter edge of the flange. The outer side wall surface extends completely around the inner perimeter edge of the flange and extends completely around the outer perimeter edge of the top surface. As the outer side wall surface extends from the outer perimeter edge of the top surface to the inner perimeter edge of the flange, the outer side wall surface slopes downwardly away from or angles downwardly away from the outer perimeter edge of the top surface. This forms the outer side wall surface as a sloped surface or a slanted surface. Also, as the outer side wall surface extends from the inner perimeter edge of the flange to the outer perimeter edge of the top surface, the outer side wall surface inclines upwardly toward or angles upwardly toward the outer perimeter edge of the top surface. This forms the outer side wall surface as an inclined surface or a slanted surface.

In the method of using the substructure in manufacturing a hybrid sandwich-structured composite panel, one or more layers of carbon fiber reinforced composite material are laid up on a tool surface. A sheet of film adhesive is then laid up on the one or more layers of composite material positioned on the tool surface.

The substructure is then positioned on the sheet of film adhesive, with the sheet of film adhesive adhering the substructure to the one or more layers of composite material positioned on the tool surface. Additional sheets of film adhesive or an adhesive is applied to the inner side wall surface surrounding the cavity of the substructure and to the support surface at the bottom of the cavity.

In an alternative method of using the substructure in manufacturing a hybrid sandwich-structured composite panel, a tool surface is not used. The sheet of film adhesive is positioned on the bottom surface of the substructure. One or more layers of composite material are positioned on the sheet of film adhesive. The sheet of film adhesive adheres the one or more layers of composite material to the bottom surface of the substructure. Additional sheets of film adhesive or an adhesive is applied to the inner side wall surface surrounding the cavity of the substructure and to the support surface at the bottom of the cavity.

A core of a sandwich-structured composite panel is then positioned in the hybrid core bay or the cavity in the substructure. The sheet of film adhesive or the adhesive previously applied to the inner side wall surface surrounding the cavity of the substructure and to the support surface at the bottom of the cavity adhere the core to the substructure in the cavity.

A further sheet of film adhesive is then laid up over the core in the cavity of the substructure, over the top surface of the core, over the top surface of the substructure, over the outer side wall surface of the substructure and over the flange of the substructure. This further sheet of film adhesive adheres the core to the top surface of the substructure, the outer side wall surface of the substructure and the flange of the substructure.

One or more additional layers of carbon fiber reinforced composite material are then laid up over the further sheet of film adhesive.

The component parts of the hybrid sandwich-structured composite panel assembled together as described above are then vacuum bagged, are subjected to autoclave processing and are cured to form the hybrid sandwich-structured composite panel. The substructure provides support to the core during autoclaving and cure, prevents core crush, and enables the use of a lighter density core in the substructure cavity that reduces the weight of the hybrid sandwich-structured composite panel while providing the required stiffness.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

FIG. 1 is a representation of a perspective plan view of the substructure of this disclosure.

FIG. 2 is a representation of a side elevation view of a cross-section through a hybrid sandwich-structured composite panel of this disclosure manufactured using the substructure.

FIG. 3 is a representation of a perspective view of the substructure of this disclosure with a sheet of film adhesive or a liquid adhesive applied to the substructure.

FIGS. 4A and 4B are representations of initial steps involved in the manufacturing of a hybrid sandwich-structured composite panel comprising the substructure.

FIGS. 5A and 5B are representations of further steps involved in manufacturing a hybrid sandwich-structured composite panel comprising the substructure.

FIG. 6 is a representation of a still further step of constructing a hybrid sandwich-structured composite panel comprising substructure.

FIGS. 7A and 7B are representations of still further steps involved in manufacturing a hybrid sandwich-structured composite panel comprising the substructure.

FIG. 8 is a representation of a still further step in manufacturing a hybrid sandwich-structured composite panel comprising the substructure.

FIG. 9 is a representation of a hybrid sandwich-structured composite panel comprising the substructure.

FIG. 10 is a representation of a perspective plan view of a corner portion of a hybrid sandwich-structured composite panel manufactured using the substructure.

### DETAILED DESCRIPTION

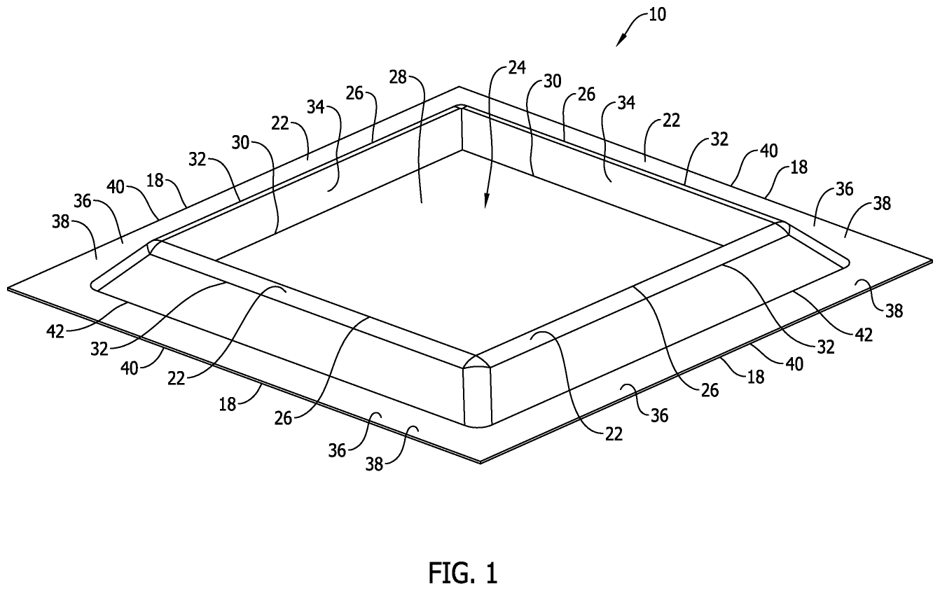

FIG. 1 is a representation of a perspective plan view of the substructure 10 used in manufacturing the hybrid sandwich-structured panel of this disclosure. As represented in FIG. 1, the substructure 10 has a general rectangular configuration resembling a picture frame configuration. However, this is only one example of a possible configuration of the substructure 10. The substructure 10 can be manufactured having various different configurations that best suit the substructure 10 for its use in the manufacturing of a hybrid sandwich-structured composite panel, as will be described. For example, if the hybrid sandwich-structured composite panel being manufactured using the substructure 10 has a triangular or circular configuration, then the substructure 10 will have a triangular or circular configuration, respectively. The hybrid sandwich-structured composite panel manufactured using the substructure 10 can be used in the manufacturing of various different lightweight and rigid articles such as aerospace component parts, aircraft component parts, vehicle component parts, marine vessel component parts, etc. The substructure 10 is constructed of a material that enables the substructure to withstand high vacuum pressures and high temperatures, such as those associated with an autoclaving process and a cure cycle. As one example, the substructure 10 can be constructed of a thermoplastic material such as polylactic acid (PLA), and manufactured in its desired configuration by stereolithography (SLA) printing or other equivalent types of additive manufacturing.

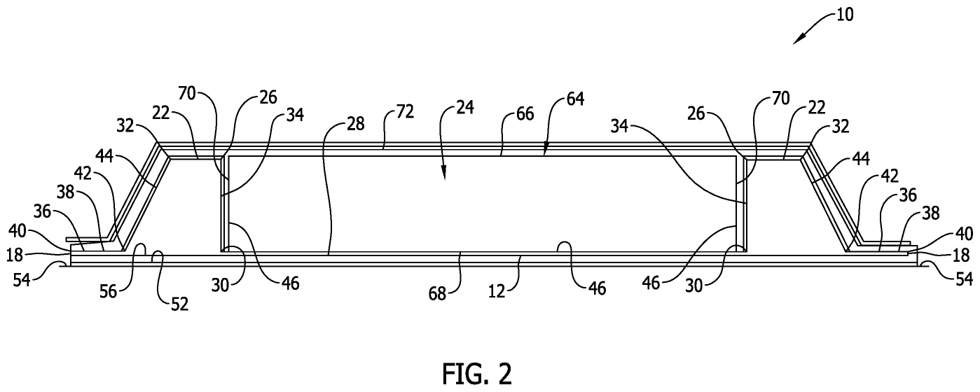

As represented in FIGS. 1 and 2, the substructure 10 is shown having a general rectangular configuration. The substructure 10 has a planar, bottom surface 12. The bottom surface 12 has an outer perimeter edge 18 that extends around the bottom surface. The bottom surface 12 is continuous inside the outer perimeter edge 18.

Although the substructure 10 is represented in FIGS. 1 and 2 as having a planar, bottom surface 12, the bottom surface 12 could have other configurations. For example, where the substructure 10 is to be used in the manufacturing of a hybrid sandwich-structured composite panel that is part of an aircraft fuselage, the substructure 10 and the bottom surface 12 will have curved configurations to match the curvature of the fuselage.

The substructure 10 also has a planar, top surface 22 above the bottom surface 12. The top surface 22 and the bottom surface 12 are parallel. Where the bottom surface 12 of the substructure 10 has a curvature, the top surface 22 will have a matching curvature. The top surface 22 has a cavity 24 recessed into the top surface at a central location of the top surface. The top surface 22 has an inner perimeter edge 26 that extends completely around the cavity 24 in the top surface. The cavity 24 extends downward from the inner perimeter edge 26 of the top surface to a support surface 28 at a bottom of the cavity 24. The support surface 28 is spaced above the bottom surface 12 of the substructure and is parallel with the bottom surface. If the bottom surface 12 has a curvature, the support surface 28 will have a curvature that matches the curvature of the bottom surface 12. The support surface 28 has an outer perimeter edge 30 that extends around the support surface and is coincident with the inner perimeter edge 26 of the top surface 22. The top surface 22 also has an outer perimeter edge 32 that extends completely around the top surface and extends around the inner perimeter edge 26 of the top surface. The outer perimeter edge 32 of the top surface 22 and the inner perimeter edge 26 of the top surface are coplanar.

The outer perimeter edge 18 of the bottom surface 12 has a length dimension. The outer perimeter edge 32 of the top surface 22 has a length dimension. The length dimension of the outer perimeter edge 18 of the bottom surface 12 is larger than the length dimension of the outer perimeter edge 32 of the top surface 22, and the outer perimeter edge 18 of the bottom surface 12 extends around and is spaced outwardly from the outer perimeter edge 32 of the top surface 22.

An inner side wall surface 34 extends between the inner perimeter edge 26 of the cavity 24 in the top surface 22 and the outer perimeter edge 30 of the support surface 28 at the bottom of the cavity. The inner side wall surface 34 is oriented perpendicular to the support surface 28 and the top surface 22. The inner side wall surface 34 extends completely around the volume of the cavity 24, the inner perimeter edge 26 of the cavity 24 in the top surface 22 and the outer perimeter edge 30 of the support surface 28. Alternatively, the inner side wall surface 34 could be formed in separate, spaced sections of the inner side wall surface 34 that are spatially arranged around the outer perimeter edge 30 of the support surface 28 and around the inner perimeter edge 26 of the cavity 24 in the top surface 22. The inner side wall surface 34 defines a volume of a hybrid core bay or the cavity 24 in the substructure 10 between the support surface 28 and the top surface 22.

A flange 36 or tab extends completely around the periphery of the substructure 10. The flange 36 is configured as a frame, similar to a picture frame around the substructure 10 The flange 36 has a planar top surface 38. A peripheral portion of the bottom surface 12 forms the bottom surface of the flange 36. The flange top surface 38 is parallel with the bottom surface 12, the top surface 11 of the substructure and the support surface 28 of the cavity 24. Where the substructure 10 has a curvature with the bottom surface 12 having a curvature, the flange 36 top surface 38 will have a curvature that matches the curvature of the bottom surface 12. The flange 36 has an outer perimeter edge 40 that extends completely around the flange. The outer perimeter edge 40 of the flange 36 is coincident with the outer perimeter edge 18 of the bottom surface 12. The flange 36 has an inner perimeter edge 42 spaced inwardly from the outer perimeter edge 40 of the flange.

An outer side wall surface 44 extends between the inner perimeter edge 42 of the flange 36 and the outer perimeter edge 32 of the top surface 22. The outer side wall surface 44 extends completely around the inner perimeter edge 42 of the flange 36 and extends completely around the outer perimeter edge 32 of the top surface 22. Alternatively, the outer side wall surface 44 could be formed in separate, spaced sections of the outer side wall surface that are spatially arranged around the inner perimeter edge 42 of the flange 36 and spatially arranged around the outer perimeter edge 32 of the top surface 22. The inner perimeter edge 42 of the flange 36 has a length dimension that is larger than the length dimension of the outer perimeter edge 32 of the top surface 22. With the length dimension of the inner perimeter edge 42 of the flange 36 being larger than the length dimension of the outer perimeter edge 32 of the top surface 22, as the outer side wall surface 44 extends from the outer perimeter edge 32 of the top surface 22 to the inner perimeter edge 42 of the flange 36, the outer side wall surface 44 has a sloped configuration that slopes downwardly away from or angles downwardly away from the outer perimeter edge 32 of the top surface 22. This forms the outer side wall surface 44 as a sloped surface or a slanted surface. Also, as the outer side wall surface 44 extends from the inner perimeter edge 42 of the flange 36 to the outer perimeter edge 32 of the top surface 22, the outer side wall surface 44 inclines upwardly toward or angles at an acute angle upwardly toward the outer perimeter edge 32 of the top surface 22. This forms the outer side wall surface 44 as an inclined surface or a slanted surface.

With the inner side wall surface 34 being oriented perpendicular to the support surface 28 and the top surface 22, and with the outer side wall surface 44 oriented at an angle relative to the bottom surface 12 and the top surface 22, the cross-section of the substructure 10 has a polygonal configuration as represented in FIG. 2.

The bottom surface 12, the top surface 22, the inner side wall surface 34, the outer side wall surface 44 and the flange 36 are all connected integrally as one piece. As stated earlier, the substructure 10 could be manufactured in its desired configuration by SLA printing, or by other equivalent methods of additive manufacturing.

In the method of using the substructure 10 in the manufacturing of a hybrid sandwich-structured composite panel, sheets of film adhesive or a liquid adhesive 46 are applied to the support surface 28 at the bottom of the cavity 24 and the inner side wall surface 34 surrounding the cavity. This is represented in FIGS. 2 and 3.

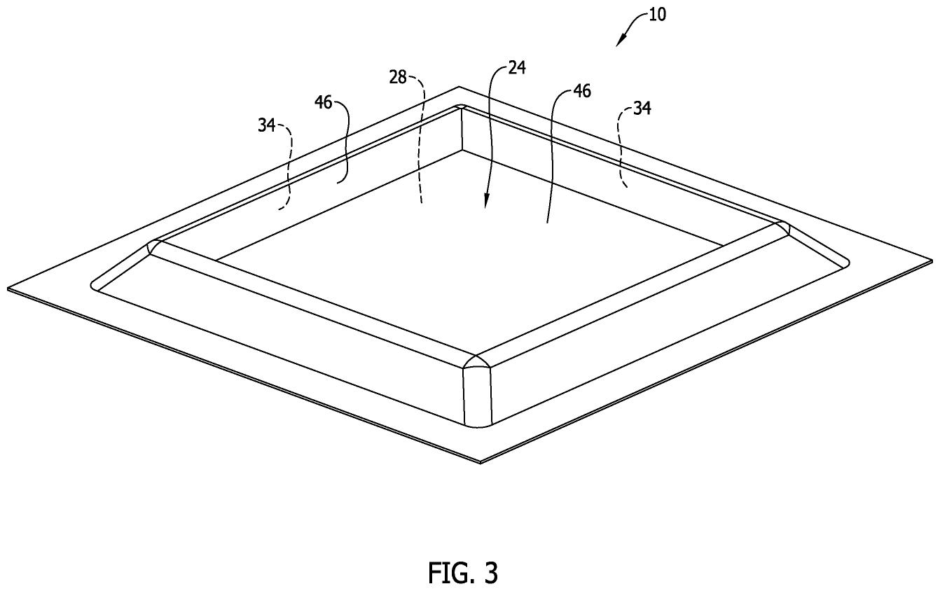

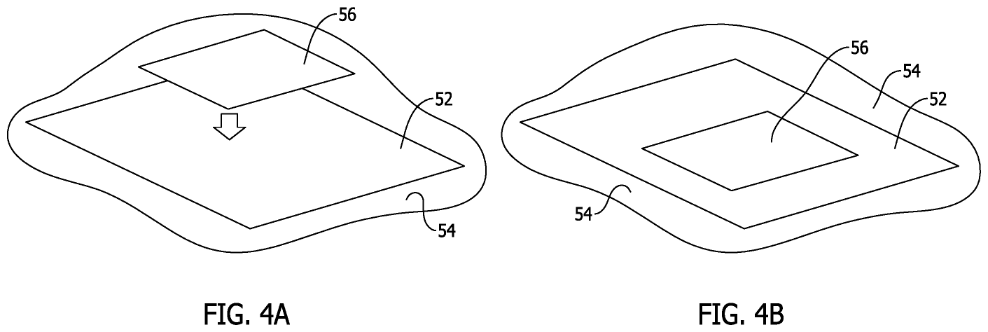

With the substructure 10 prepared with the application of adhesive 46 in the cavity 24, a first layer of material 52 or one or more layers of material, such as carbon fiber reinforced composite material 52 are laid up on a tool surface 54. A sheet of film adhesive 56 is then laid up on the one or more layers of composite material 52 positioned on the tool surface 54, or a liquid adhesive is applied to the layers of material. This is represented in FIGS. 4A and 4B.

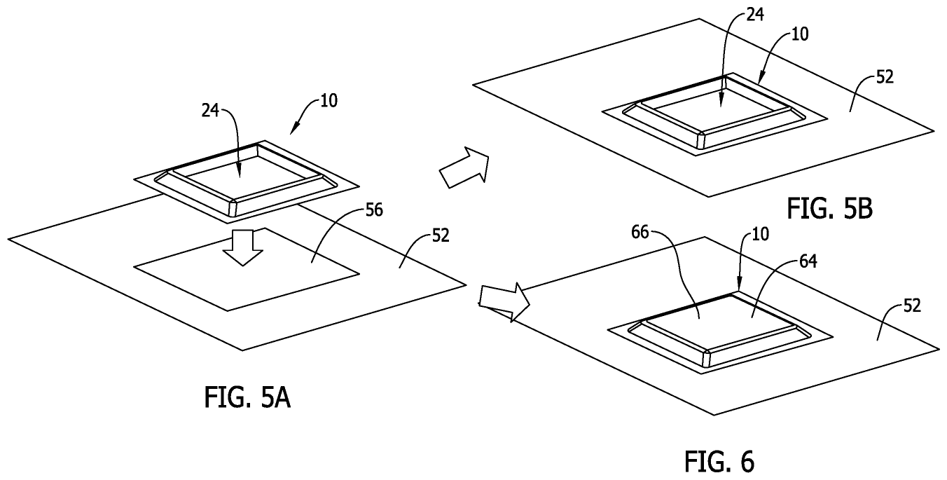

The bottom surface 12 of the substructure 10 is then positioned on the sheet of film adhesive 56, with the sheet of film adhesive 56 adhering to the bottom surface 12 of the substructure 10. This adheres the bottom surface 12 of the substructure 10 to the one or more layers of composite material 52 positioned on the tool surface 54. This is represented in FIGS. 5A and 5B.

Alternatively, the sheet of film adhesive 56 could be laid up on, the bottom surface 12 of the substructure 10 without the use of a tool surface 54. The sheet of film adhesive 56 is first laid up on the bottom surface 12 of the substructure 10. One or more layers of material, such as carbon fiber reinforced composite material 52 are then laid up on the sheet of film adhesive 56. This adheres the one or more layers of composite material 52 to the bottom surface 12 of the substructure 10.

A core 64 is then positioned in the hybrid core bay or cavity 24 in the substructure 10. The core 64 is constructed of a material having a lesser density or reduced density of the material used in constructing the substructure 10. The core 64 has a top surface 66, an opposite bottom surface 68 and an outer side wall surface 70 that extends completely around the core. The bottom surface 68 of the core 64 is positioned against the sheet of film adhesive or liquid adhesive 46 applied to the support surface 28 of the cavity 24 and the outer side wall surface 70 of the core 64 is positioned against the sheet of film adhesive or liquid adhesive 46 applied to the inner side wall surface 34 of the cavity 24. This adheres the core 64 to the support surface 28 and the inner side wall surface 34 inside the cavity 24. This is represented in FIG. 6. What is meant by a core 64 is any type of core of a low density material typically used in the manufacture of sandwich-structured panels, such as a honeycomb core, a foam core, a balsa wood core, a metal lattice core, etc. With the core 64 positioned in the cavity 24 of the substructure 10, a top surface 66 of the core 64 is substantially coplanar with the top surface 22 of the substructure 10. The sheet of film adhesive or liquid adhesive 46 previously applied to the support surface 28 of the cavity 24 and the inner side wall surface 34 of the cavity 24 adhere the core 64 to the substructure 10 inside the cavity 24.

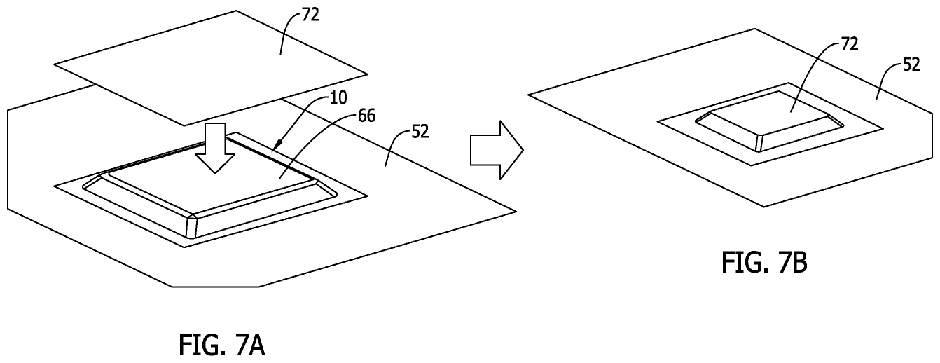

A further sheet of film adhesive or a liquid adhesive 72 is then laid up on the top surface 66 of the core 64 in the cavity 24 of the substructure 10, on the top surface 22 of the substructure 10, on the outer side wall surface 44 of the substructure 10 and on the top surface 38 of the flange 36, This is represented in FIGS. 7A and 7B. This further sheet of film adhesive 72 adheres the core 64 to the top surface 22 of the substructure 10, to the outer side wall surface 44 of the substructure 10 and to the flange 36.

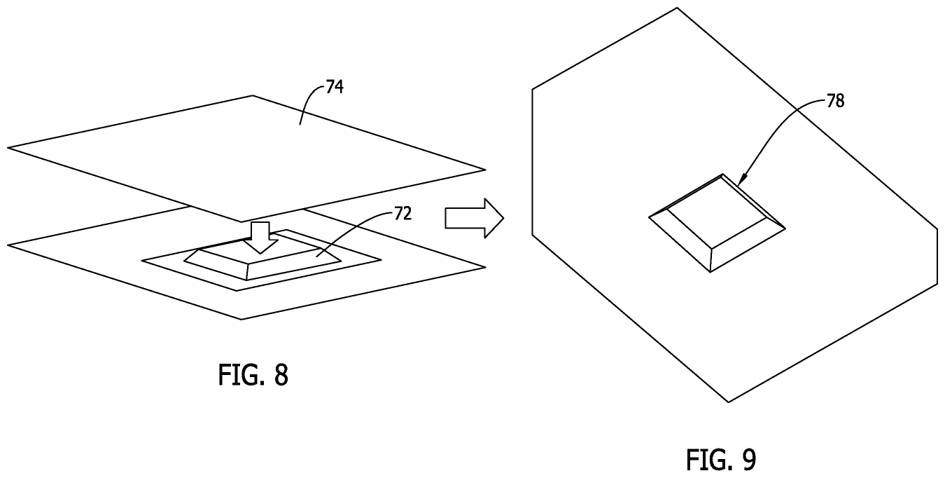

A second layer of material 74 or one or more additional layers of material, such as carbon fiber reinforced composite material 74 are then laid up over the further sheet of film adhesive 72. This is represented in FIG. 8. The one or more additional layers of carbon fiber reinforced composite material 74 extend over the core 64, over the top surface 22 of the substructure 10, over the outer side wall surface 44 of the substructure 10 and the flange 36.

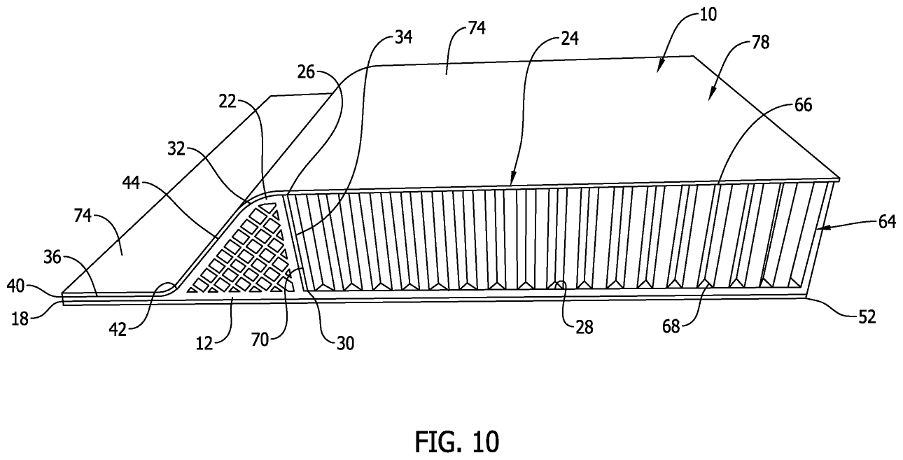

The component parts of a hybrid sandwich-structure composite panel 78 assembled together as described above are then vacuum bagged, or subjected to autoclave processing and are cured to form the hybrid sandwich-structured composite panel 78. This is represented in FIG. 9. A cross-section view of a corner portion of the hybrid sandwich-structured composite panel 78 is represented in FIG. 10. The substructure 10 provides support to the core 64 during autoclaving and cure, prevents core crush during autoclaving and cure and enables the use of a lighter density core 64 in the cavity 24 of the substructure 10 that reduces the weight of the hybrid sandwich-structured composite panel 78 while maintaining a required stiffness of the hybrid sandwich-structured composite panel 78.

As various modifications could be made in the construction of the apparatus and the method of operation of the apparatus herein described and illustrated without departing from the scope of the invention, it is intended that all matter contained in the foregoing description or shown in the accompanying drawings shall be interpreted as illustrative rather than limiting. Thus, the breadth and scope of the present disclosure should not be limited by any of the above described exemplary embodiments, but should be defined only in accordance with the following claims appended hereto and their equivalents.

1. A hybrid sandwich-structured panel comprising:
a substructure, the substructure having a cavity;
a core positioned in the cavity of the substructure, the substructure extending around the core and containing the core in the cavity of the substructure;
a first layer of material secured to the substructure; and,
a second layer of material secured to the substructure and secured to the first layer of material, the substructure and the core positioned in the cavity of the substructure being sandwiched between the first layer of material and the second layer of material.

2. The hybrid sandwich-structured panel of claim 1, further comprising:
the core being a core for a sandwich-structured composite panel.

3. The hybrid sandwich-structured panel of claim 1, further comprising:
the core being a honeycomb structure.

4. The hybrid sandwich-structured panel of claim 1, further comprising:
the substructure having a bottom surface;
the substructure having a top surface;
the cavity being between the bottom surface of the substructure and the top surface of the substructure; and,
the core positioned in the cavity of the substructure being between the bottom surface of the substructure and the top surface of the substructure.

5. The hybrid sandwich-structured panel of claim 4, further comprising:
the first layer of material being secured to the bottom surface of the substructure and completely covering the bottom surface of the substructure; and,
the second layer of material being secured to the top surface of the substructure and completely covering the top surface of the substructure and completely covering the core positioned in the cavity of the substructure.

6. The hybrid sandwich-structured panel of claim 4, further comprising:
the substructure having an outer side wall surface that extends around the substructure and extends between the bottom surface of the substructure and the top surface of the substructure; and,
the outer side wall surface of the substructure being oriented at an acute angle as the outer side wall surface extends between the bottom surface of the substructure and the top surface of the substructure.

7. The hybrid sandwich-structured panel of claim 6, further comprising:
the first layer of material is secured to the bottom surface of the substructure and completely covers the bottom surface of the substructure; and,
the second layer of material is secured to the top surface of the substructure and the outer side wall surface of the substructure and completely covers the top surface of the substructure, the core positioned in the cavity of the substructure and the outer side wall surface of the substructure.

8. The hybrid sandwich-structured panel of claim 1, further comprising:
the substructure being constructed of a first material, the first material having a first density;
the core being constructed of a second material, the second material having a second density; and,
the first density being more dense than the second density.

9. The hybrid sandwich-structured panel of claim 1, further comprising:
the substructure having an inner side wall surface, the inner side wall surface extending around the cavity; and,
the core having an outer side wall surface, the outer side wall surface of the core extending around the core, the outer side wall surface of the core opposing the inner side wall surface of the substructure with the core positioned in the cavity of the substructure.

10. A hybrid sandwich-structured panel comprising:
a substructure, the substructure having a cavity in the substructure;
a core positioned in the cavity in the substructure, the substructure supporting the core in the cavity and providing compression reinforcement to the core;
a first layer of composite material secured to the substructure; and,
a second layer of composite material secured to the substructure and secured to the first layer of composite material with the substructure and the core positioned in the cavity of the substructure being sandwiched between the first layer of composite material and the second layer of composite material.

11. The hybrid sandwich-structured panel of claim 10, further comprising:
the core being a core used in the manufacturing of sandwich-structured panels.

12. The hybrid sandwich-structured panel of claim 10, further comprising:
the core being configured as a two-dimensional array of hollow cells.

13. The hybrid sandwich-structured panel of claim 10, further comprising:
the substructure having a bottom surface;
the substructure having a top surface; and,
the cavity being recessed into the top surface of the substructure with the cavity being positioned between the bottom surface and the top surface of the substructure and with the core positioned in the cavity being between the bottom surface and the top surface of the substructure.

14. The hybrid sandwich-structured panel of claim 13, further comprising:
the first layer of composite material being adhered to the bottom surface and completely covering the bottom surface; and,
the second layer of composite material being adhered to the top surface and completely covering the top surface and the core positioned in the cavity recessed into the top surface.

15. The hybrid sandwich-structured panel of claim 13, further comprising:
the substructure having an outer side wall surface that extends around the substructure and between the bottom surface of the substructure and the top surface of the substructure, the outer side wall surface being inclined as the outer side wall surface extends between the bottom surface of the substructure and the top surface of the substructure;
the first layer of composite material is adhered to the bottom surface of the substructure and completely covers the bottom surface of the substructure; and,
the second layer of composite material is adhered to the top surface of the substructure and the outer side wall surface of the substructure and completely covers the top surface of the substructure, the core positioned in the cavity of the substructure and the outer side wall surface of the substructure.

16. The hybrid sandwich-structured panel of claim 10, further comprising:
the substructure being constructed of a first material having a first density;
the core being constructed of a second material having a second density; and,
the second material having a lesser density than the first material.

17. The hybrid sandwich-structured panel of claim 10, further comprising:
the substructure having an inner side wall surface that extends around the cavity; and,
the core having an outer side wall surface that extends around the core, the outer side wall surface of the core opposing and being adhered to the inner side wall surface of the substructure with the core positioned in the cavity of the substructure.

18. A method of manufacturing a hybrid sandwich-structured composite panel, the method comprising:
positioning a substructure on a first layer of composite material, the substructure having a bottom surface and a top surface with a cavity in the substructure between the bottom surface and the top surface;
positioning a core in the cavity of the substructure;
positioning a second layer of composite material over the substructure and over the core positioned in the cavity of the substructure;
autoclaving the first layer of composite material, the substructure with the core in the cavity of the substructure, and the second layer of composite material; and,
curing the first layer of composite material, the substructure with the core in the cavity of the substructure and the second layer of composite material producing a hybrid sandwich-structured composite panel containing the substructure and the core positioned in the cavity of the substructure between the first layer of composite material and the second layer of composite material.

19. The method of claim 18, further comprising:
reducing a weight of the hybrid sandwich-structured composite panel by positioning a reduced density core in the cavity of the substructure.

20. The method of claim 18, further comprising:
positioning the second layer of composite material on an outer side wall surface of the substructure that extends around the bottom surface and extends around the top surface and slopes away from the top surface to the bottom surface.
